(19) United States
(12) Patent Application Publication
(10) Pub. No.: US 2006/0100985 A1
(43) Pub. Date: May 11, 2006

(54) System and method of assigning seats and/or tables, as well as issuing and tracking personalized tickets for patrons attending events

(76) Inventors: Gerald Mark, Los Angeles, CA (US); Stephen Mark, Los Angeles, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/268,852

(22) Filed: Nov. 8, 2005

Related U.S. Application Data
(60) Provisional application No. 60/625,930, filed on Nov. 8, 2004.

(51) Int. Cl. G06F 17/30

(52) U.S. Cl. 707/1

(57) ABSTRACT

Coordinators create a record and gather data for attendees. The information can be personal identification information, the company they represent, and the like. Records are stored in a database. The Coordinators assign seats and/or tables to the attendees. Such assignments are automatically captured and stored in the attendee's record. The Coordinators can then print customized tickets for attendees and activate tracking devices. The Attendee receives a ticket and uses the ticket to gain access to an event.

The present application claims priority benefits under 35 U.S.C. §119(e) from U.S. Provisional Application No. 60/625,930, filed on Nov. 8, 2004, titled “System And Method Of Assigning Seats And/Or Tables, As Well As Issuing Personalized Tickets For Patrons Attending Events,” which is incorporated herein by reference. This application is related to U.S. patent application Ser. No. 11/056,523, filed on Feb. 11, 2005, titled “System and Method for Controlling Access and Credentials for Events”, the entirety of which is hereby incorporated herein by reference.

### FIELD OF THE INVENTION

The invention relates generally to gathering and storing of data on patrons attending events, assigning those patrons certain locations at such events and issuing them personalized tickets, or the like for such events.

### SUMMARY OF THE INVENTION

Embodiments of the invention provide electronic systems and methods that provide for the efficient and straightforward creation of location, parking assignments as well as personalized passes, or the like for individuals attending events. In one application, the method comprises building a database with a record for each individuals or party attending the event.

In one application, a method comprises assigning each party a seat (space, etc) and then later changing the assignment in the party's record. In an embodiment, a method comprises auto-populating a seating (space) diagram based on current seating assignment in the records in the database. In an embodiment, a method comprises dragging and dropping records into different seating spots, which attaches a new seating assignment to the record. In an embodiment, a method comprises printing a pass having unique data printed on the pass that comes from the party's unique record (table, seat, name, etc.)

In an embodiment, an RFID embedded chip, or other technology ties the current record in database to the pass with the embedded technology allowing changes to the record in the database. After printing the ticket, the record can be viewed on a display monitor upon scanning at an event entrance. In an embodiment, the seat assignment associated with the ticket can be changed after the ticket has been printed. The ticket can also be deactivated or canceled after printing.

In one application, a method comprises tracking log features for each record when the associated pass is scanned at the event entrance. In an embodiment, a method comprises storing data in real time in the party's record in the database. In an embodiment, a method comprises programming the record data onto ticket for reading at the ticket scanning points

In one application, a method of assigning seats, spots, tables, space or area and the like to parties attending an event comprises gathering data and creating a record for all parties requesting or needing a ticket, pass, spot, space assignment or the like (including when such assignment is just placed on a list and no pass is distributed), storing such record (with relevant information) on each party in a database, and modifying the record in the database to include the table, seat, spot, area and the like to each party's record. Multiple users can have access to the system and can be working in the system simultaneously.

The method further comprises sorting, searching and/or manipulating the records in the database based on any field of data entered or to be potentially entered in the future (some data-fields can be left blank and completed later), viewing records and/or editing records in form view (each record individually with some or all of data collected displayed) or in grid view (multiple records at once with some or all of data collected displayed), selecting the record in grid view and opening the record into form view, and dragging and dropping column and row headers in order to create custom views in both form and grid view.

The method further comprises saving and editing custom views/formats for recall of the view/format after new additional records and/or data to a record previously created has been added, printing any view, loading a graphical seating, spot, table, and the like, diagram of any facility or create a graphical diagram, and auto populating data collected in each record in the database into the graphical user interface seating diagram view based on the seat, table, spot, or the like, number assigned in the field in each unique record (or any other form of data collected that can be used to make assignment).

The method further comprises viewing the number of seats or the like taken or available at each table, spot, or the like, and assigning records without an assignment to a seat, table, or the like, in the graphical user interface seating assignment diagram view area. An assignment made is then automatically saved in unique record of party.

The method further comprises splitting the screen to see views of both the graphical user interface layout diagram and records (in grid or form view) sorted in any manner (by table or any other data collected in record), and pulling a record from the grid or form view and then dropping the record in the seat, table or the like, in the graphic interface diagram. The number of the seat, table, or the like, is dragged or dropped into is automatically attached and saved in attendee's unique record in database.

The method further comprises selecting a table in the graphical interface diagram and retrieving the records in grid or form view that are assigned to that table, area, or the like, and dragging a record from one table to another and thereby automatically changing the assigned seating number in the unique record in database based on the seating spot selected,

The method further comprises printing on each individual ticket, pass, list, or the like, any information stored in unique record in database, and automatically capturing and storing the date and time the ticket was printed.

In an embodiment, tickets, passes, or the like, have an embedded RFID chip, a printed bar code, or like scannable technology. When the ticket or pass is scanned and/or activated, the unique ID number of the tickets is captured and stored in database in the party's record. The method further comprises deactivating or retiring the ticket at any time before or after it has been distributed by recalling the record in the database where the unique ID is stored and making the change, changing any data in the party's record stored in the database and then having this data displayed on the scanning device which is linked to the database upon arrival (i.e. table number, seat number, note for attendee). In another embodiment, data from the party's unique database record can be programmed onto the RFID chip or other similar technology that it is attached to party's unique pass or ticket.

In an embodiment, tickets, pass and the like, with the technology can be scanned upon entrance. The method further comprises, upon scanning the chip (or similar technology) in ticket/pass, retrieving the individual's record from the database (database can be on server connect through LAN, Internet, or the like or can be loaded directly on to the display of scanning device), displaying information stored in unique record, including, but not limited, to validation of ticket and/or seat assignment, capturing and storing in the database the time and date the ticket is scanned at an event entrance, and viewing and printing scanning reports on any records in database.

In one application, a method of creating a seating chart for an event comprises creating a record in a database for at least one event attendee, storing in the record a unique code, said code uniquely associated with a pass which permits the at least one attendee admittance to an event, storing in the record for the at least one attendee a seat assignment at the event after the pass is distributed, updating the seat assignment in the database after the pass is distributed to permit a user to reassign the attendee to a different seat assignment after the pass is distributed, and communicating a most recent seat assignment stored in the database to the attendee upon presentation of the pass at the event.

In another application, a method of creating a seating chart for an event comprises creating a record in a database for at least one event attendee, displaying the created record on an electronic display electronically connected to the database, displaying a graphical seating diagram comprising at least one table icon or the like, corresponding to at least one table at an event on the electronic display, modifying the record to include a table assignment for the at least one attendee by electronically selecting the record and dropping the record onto the table icon, and updating automatically the table icon in the graphical seating diagram to indicate the number of remaining unassigned seats at the table when the record is modified to include the table assignment for the attendee.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

Figure A is a block diagram illustrating an embodiment of an online seating and/or table and ticketing assignment software system.

Figure B illustrates another embodiment of an online seating and/or table and ticketing assignment software system.

Figure C illustrates an embodiment of a seating assignment and ticketing process.

Figure D illustrates another embodiment of an arrival and ticketing tracking process.

FIG. 1 is an exemplary screen shot of a user ID/password login form, according to an embodiment of the invention.

FIG. 2 is an exemplary screen shot of a Grid View option of the software, according to an embodiment of the invention. In an embodiment, the user can search by any data obtained or, intended to be obtained in the future, in the record. In an embodiment, the user can Add, Edit, or Delete a Custom View. The user can select in which Custom View they would like to view the data, or they can move, for example, by dragging and dropping column headers, to create a temporary view, which can also be saved for future recall and use after additional data or records have been added. In an embodiment, the user can Add, Edit or Delete records/data in this view. Further, in an embodiment, the user can define how many records to have returned by a filter/sort of the database. In an embodiment, the total number of records associated with the database or selected filter/sort are viewable.

FIG. 3 is an exemplary screen shot of a Form View option of the software, according to an embodiment of the invention. In an embodiment, the Form View allows the user to view the data fields in one view as opposed to scrolling through a grid. As with the Grid View, the Guest Status data is updated in real time.

FIG. 4 is an exemplary screen shot illustrating the use of the Add, Edit, or Delete of a Custom View, according to an embodiment of the invention.

FIG. 5 is an exemplary screen shot illustrating the use of selecting a Custom View for reviewing, filtering or sorting data, according to an embodiment of the invention.

FIG. 6 is an exemplary screen shot illustrating the use of a Menu bar, according to an embodiment of the invention. In an embodiment, at anytime, regardless if the user is currently in the Grid View or the Form View, the user can select options/software functions from the drop down menus associated to the Menu Bar. In this example associated with the Main Menu, the user can opt to directly visit the Seating Chart Diagram for a real time account of the records that have been assigned a seat/table number. In an embodiment, the user can view several different printing options, such as, portrait, landscape, paper selection, margin size, etc. In an embodiment, the user can turn grid lines On or Off, or the user can exit the application. The data is automatically saved once the user exits a data/text field. In an embodiment, multiple coordinators can be inputting records or assigning seats in the system at the same time from multiple computers networked to one another.

FIG. 7 is an exemplary screen shot illustrating the View option in the Menu Bar, according to an embodiment of the invention. For example, the user can easily navigate through the software by selecting a View. In an embodiment, the user has four static views to choose from, Examples of the Views are Live User Data, Printed Tickets, Tickets Not Printed, and Retired Tickets.

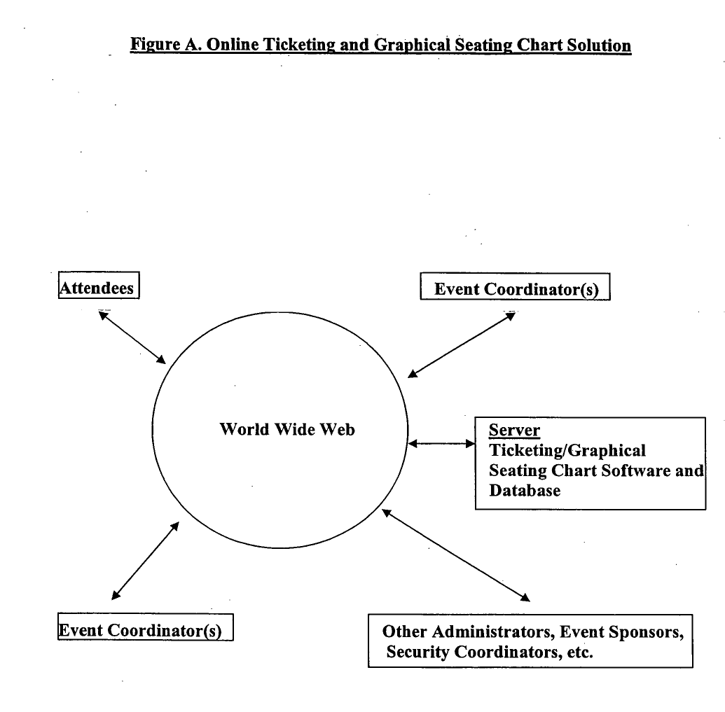

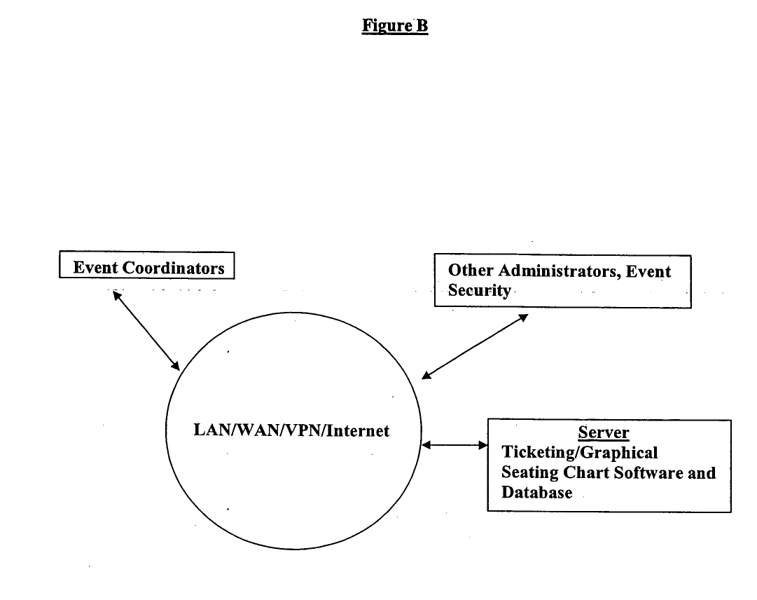

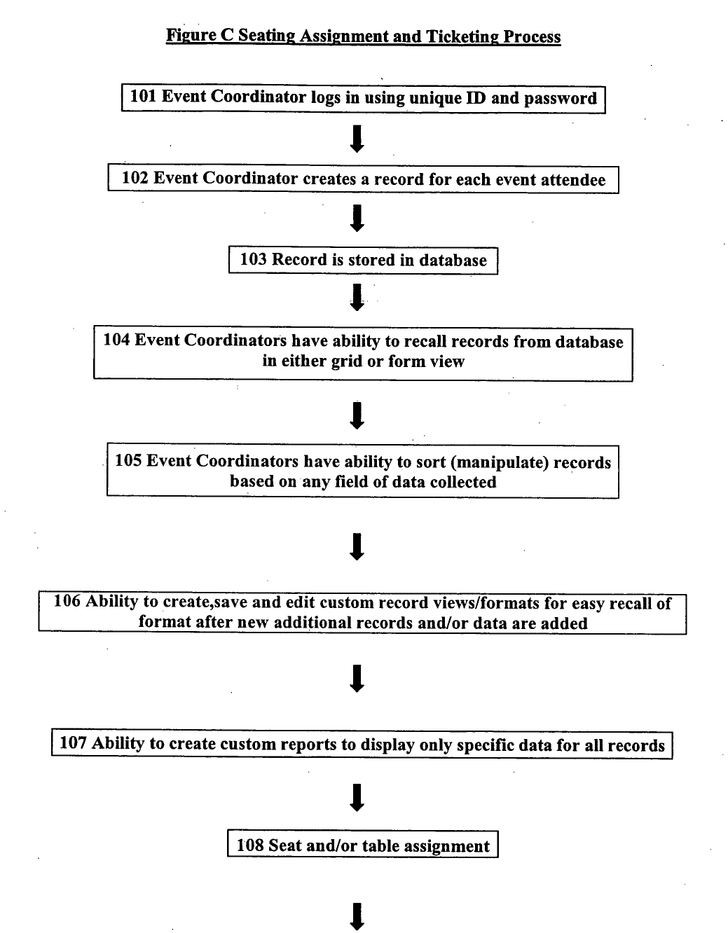

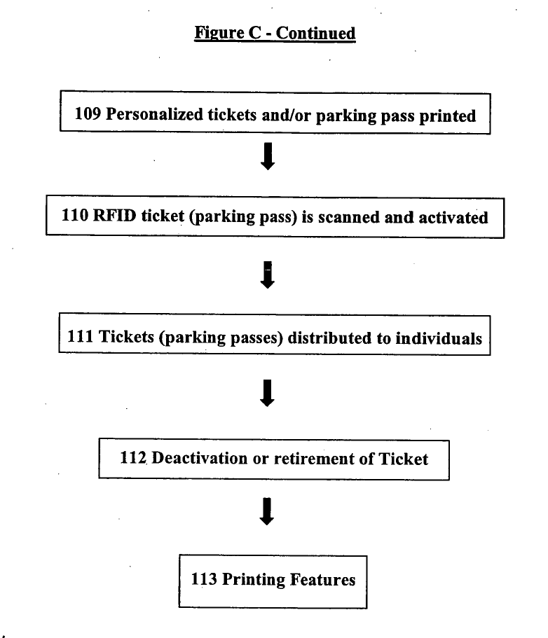

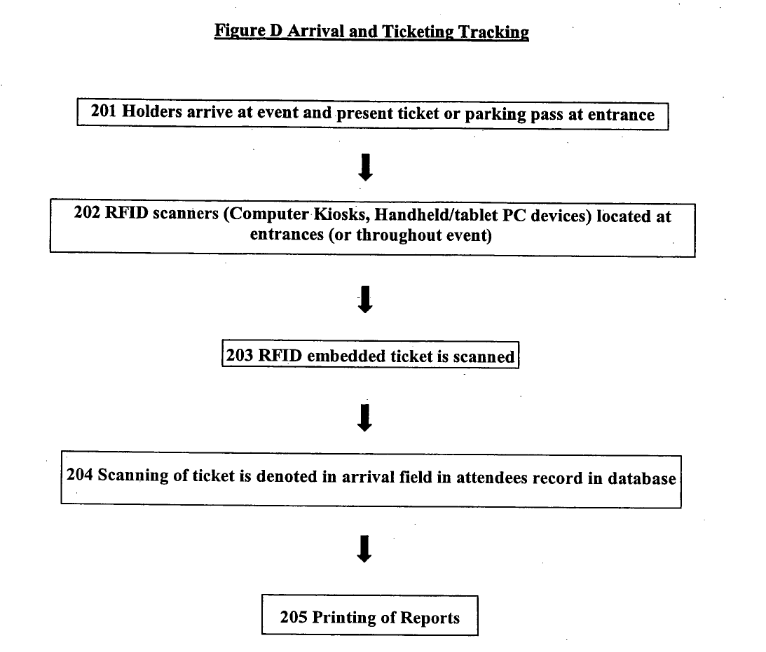

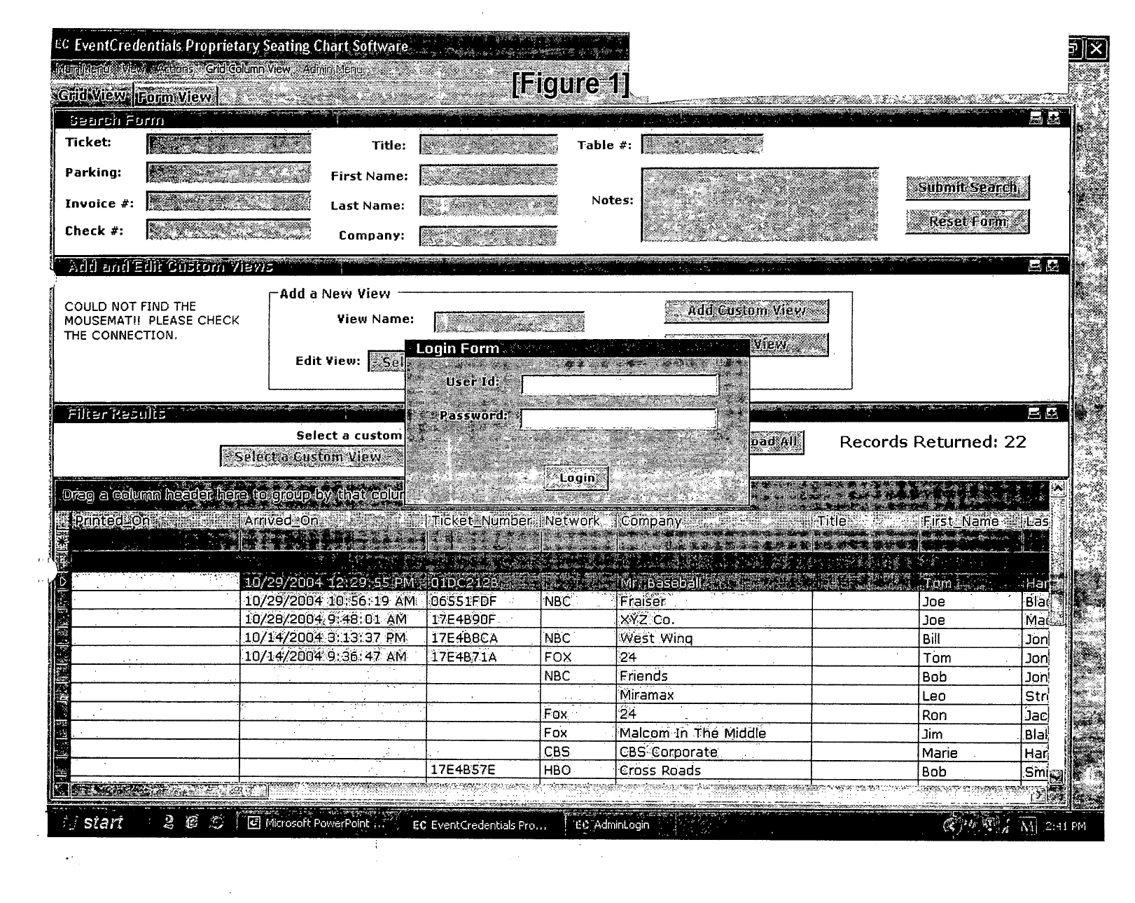

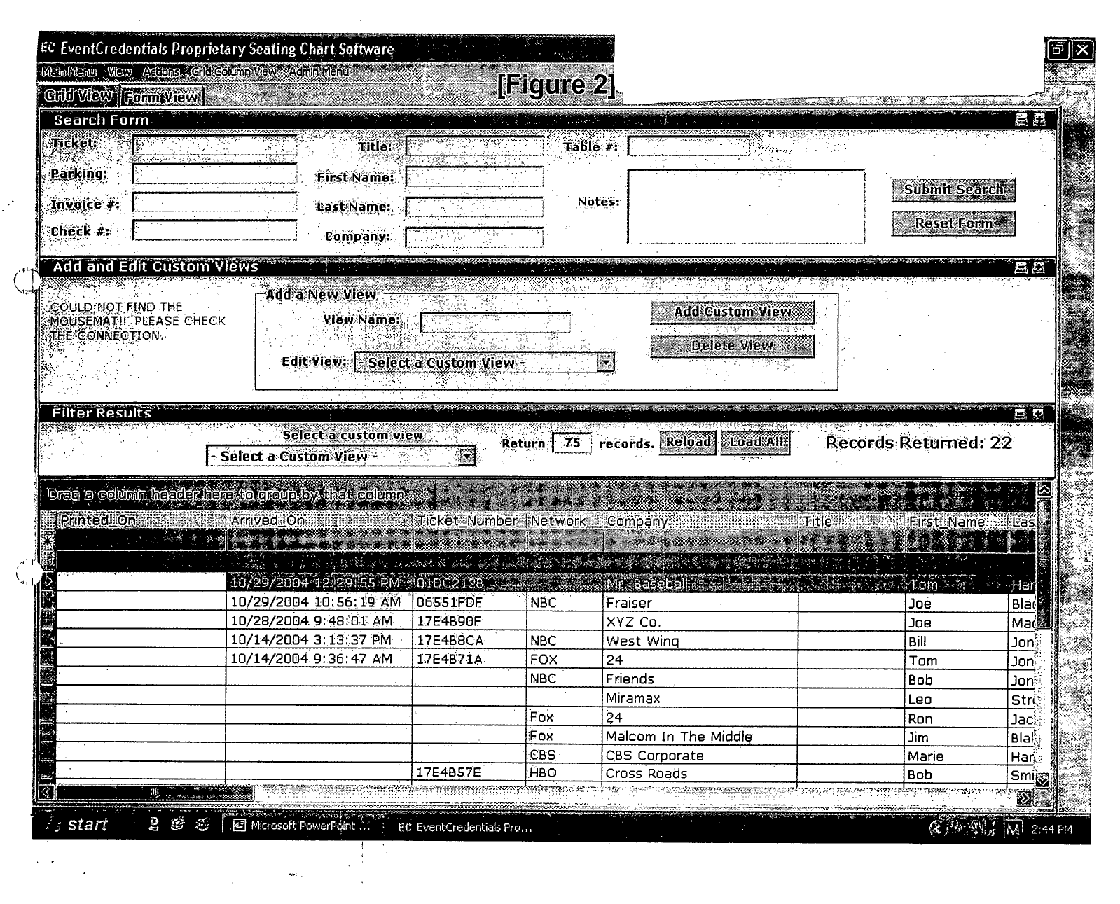

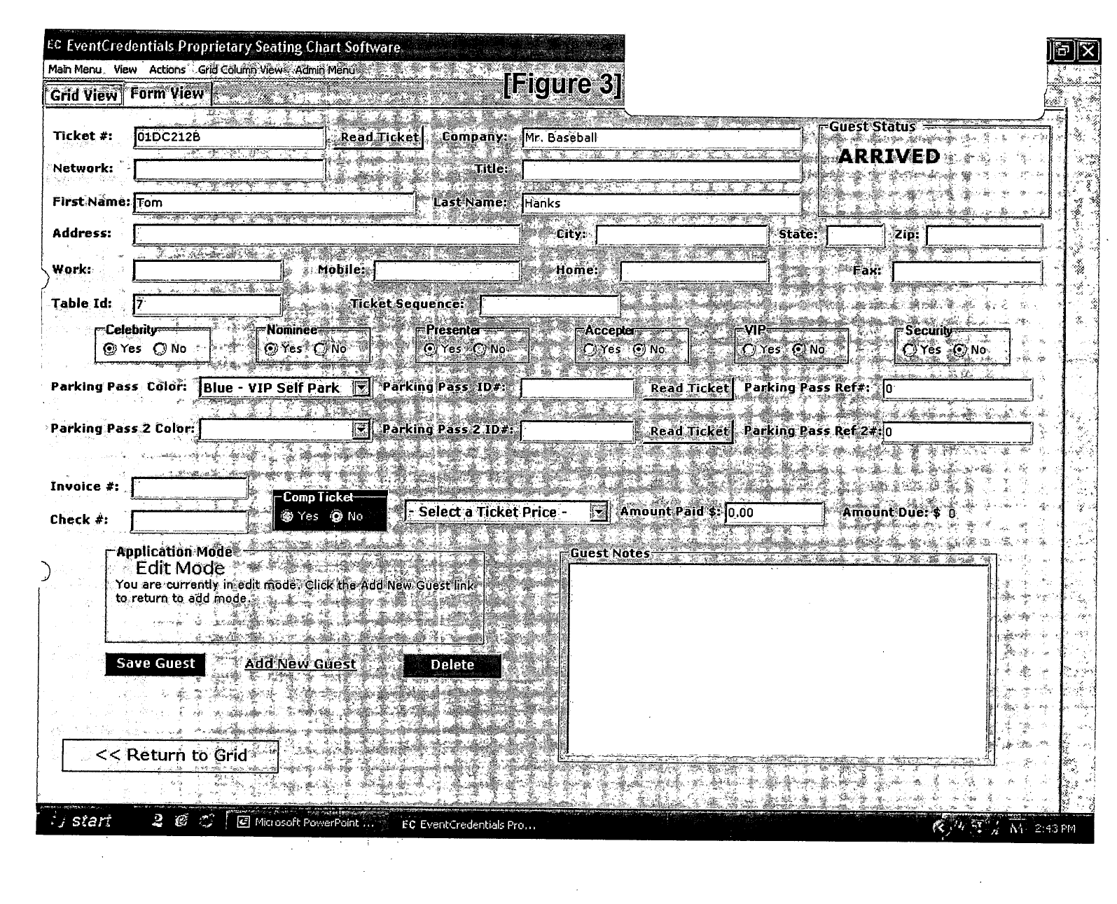

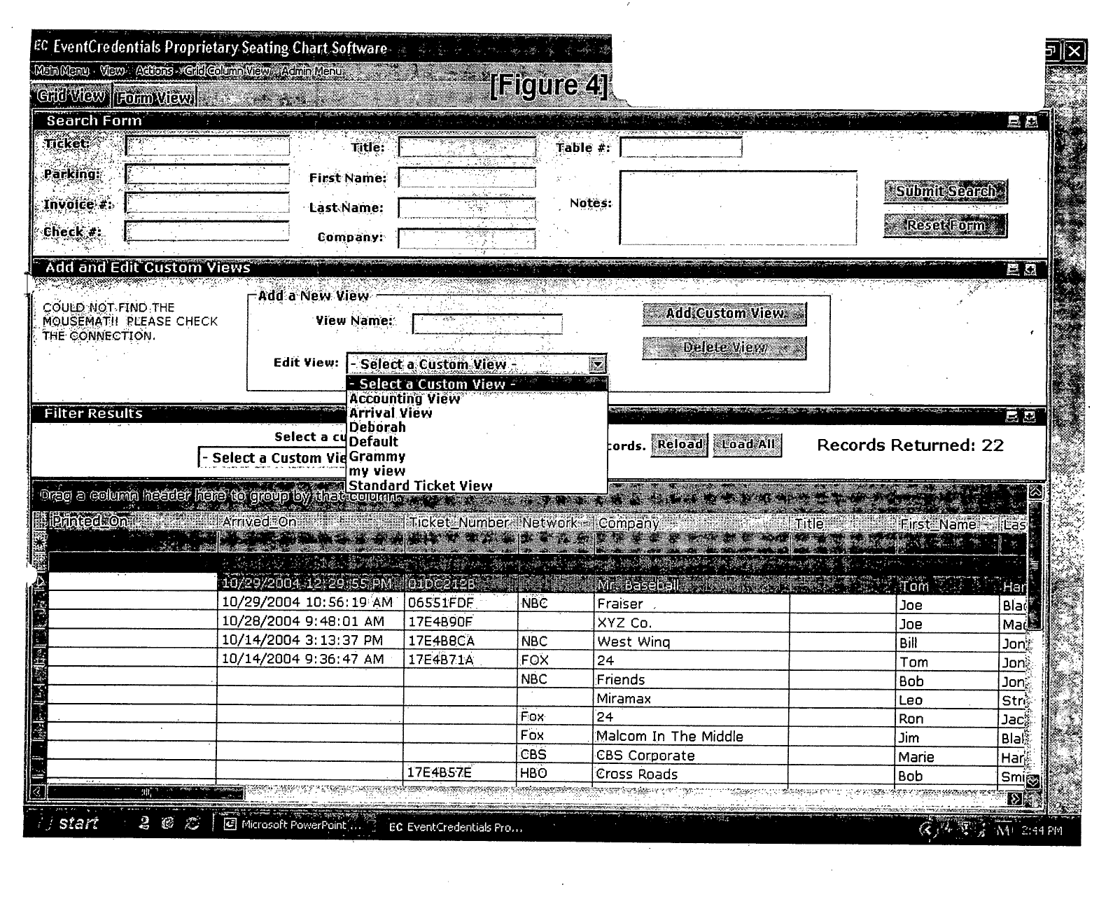

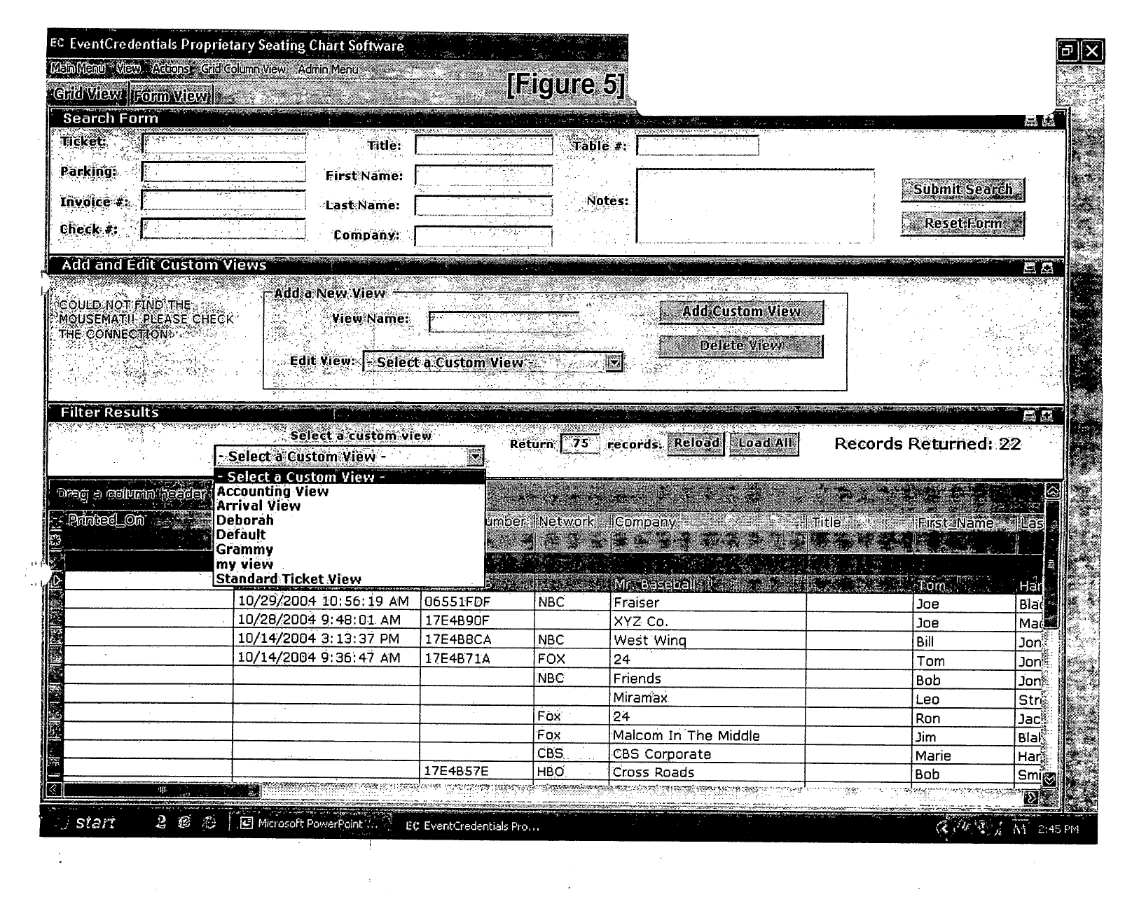

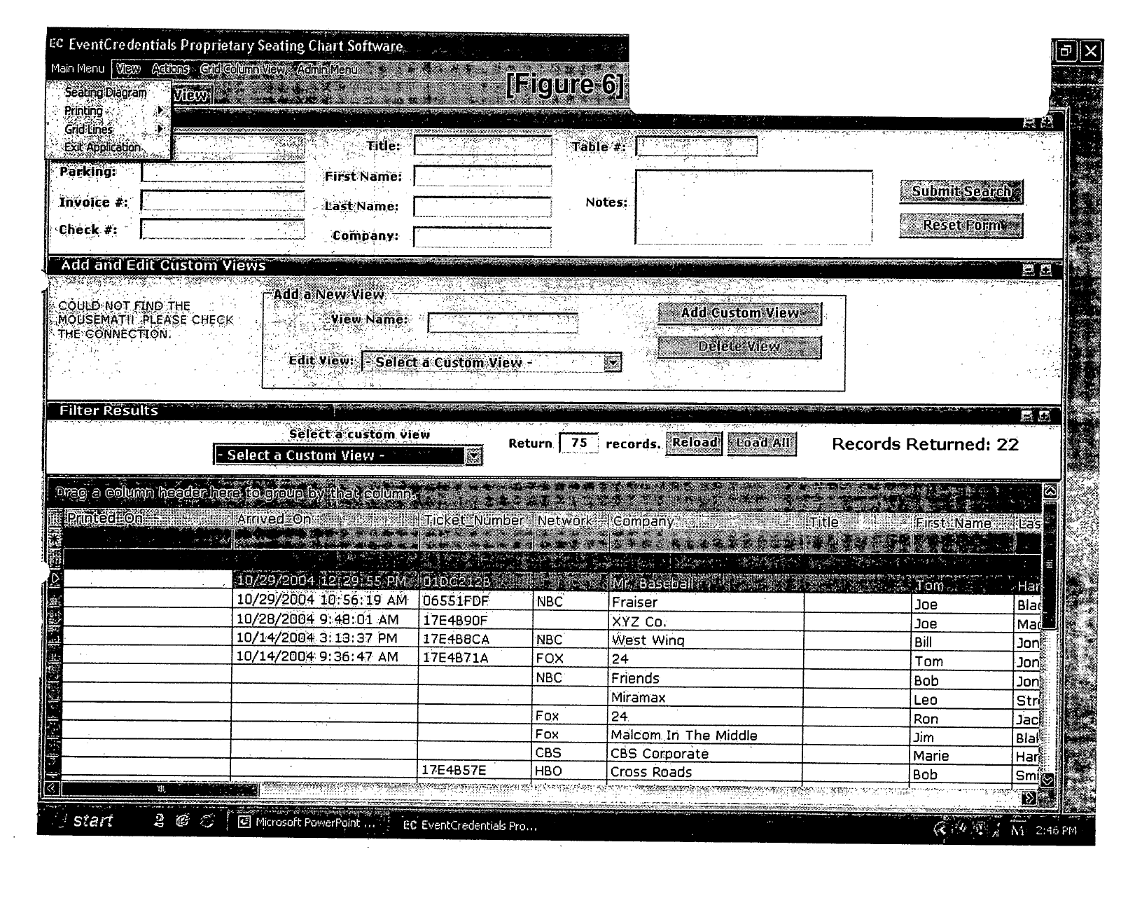

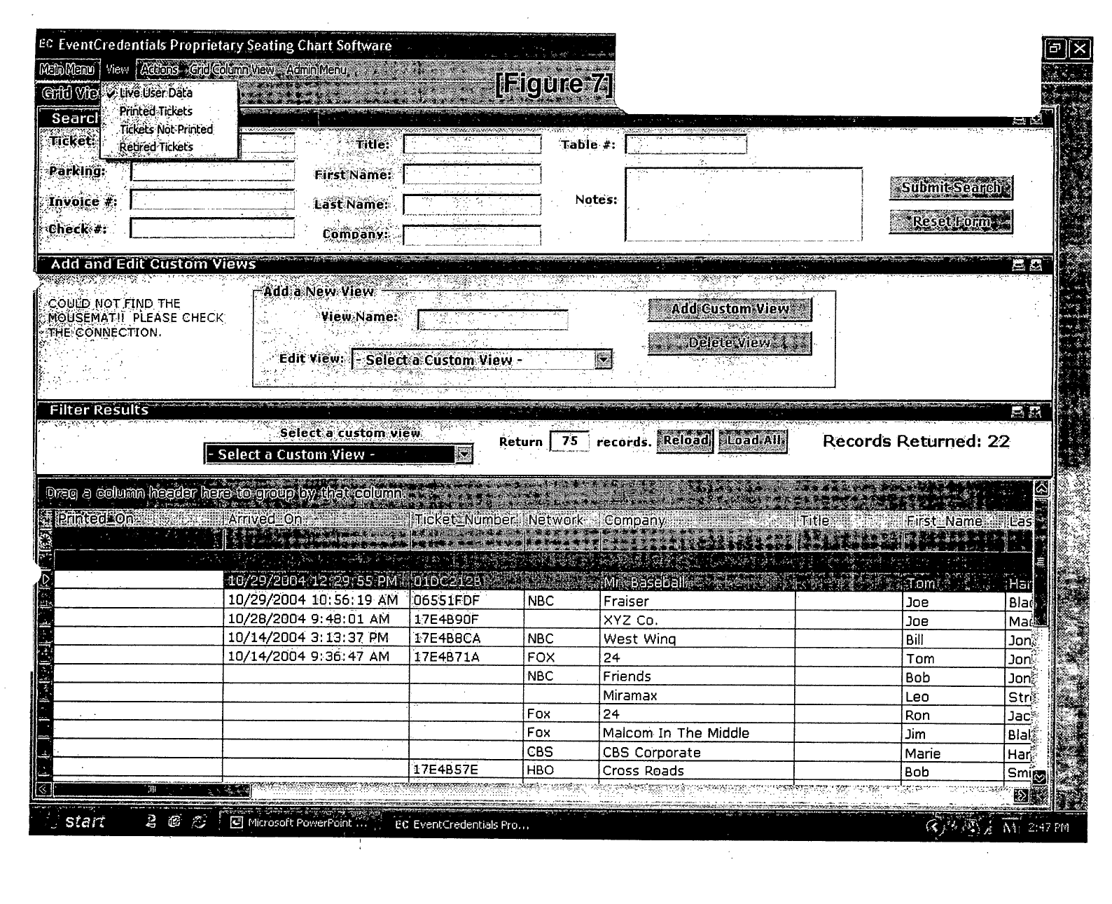

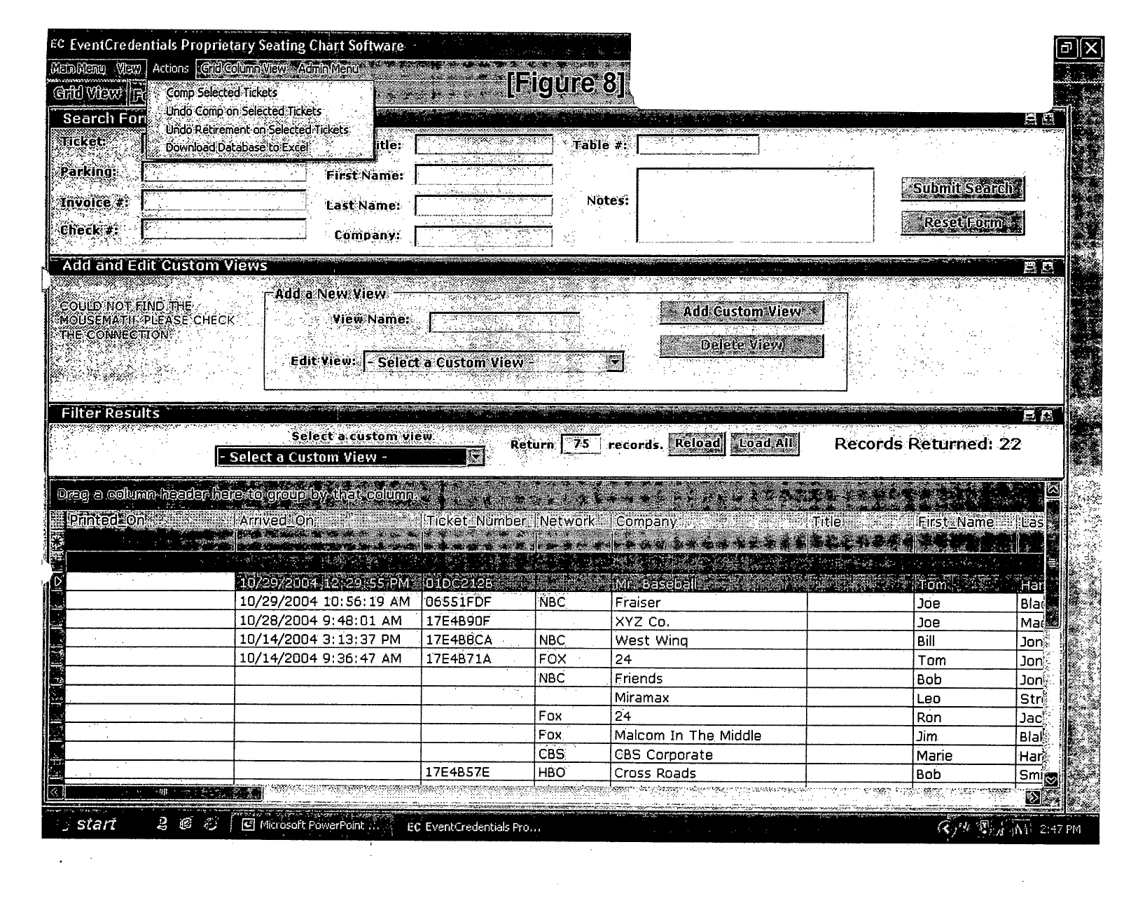

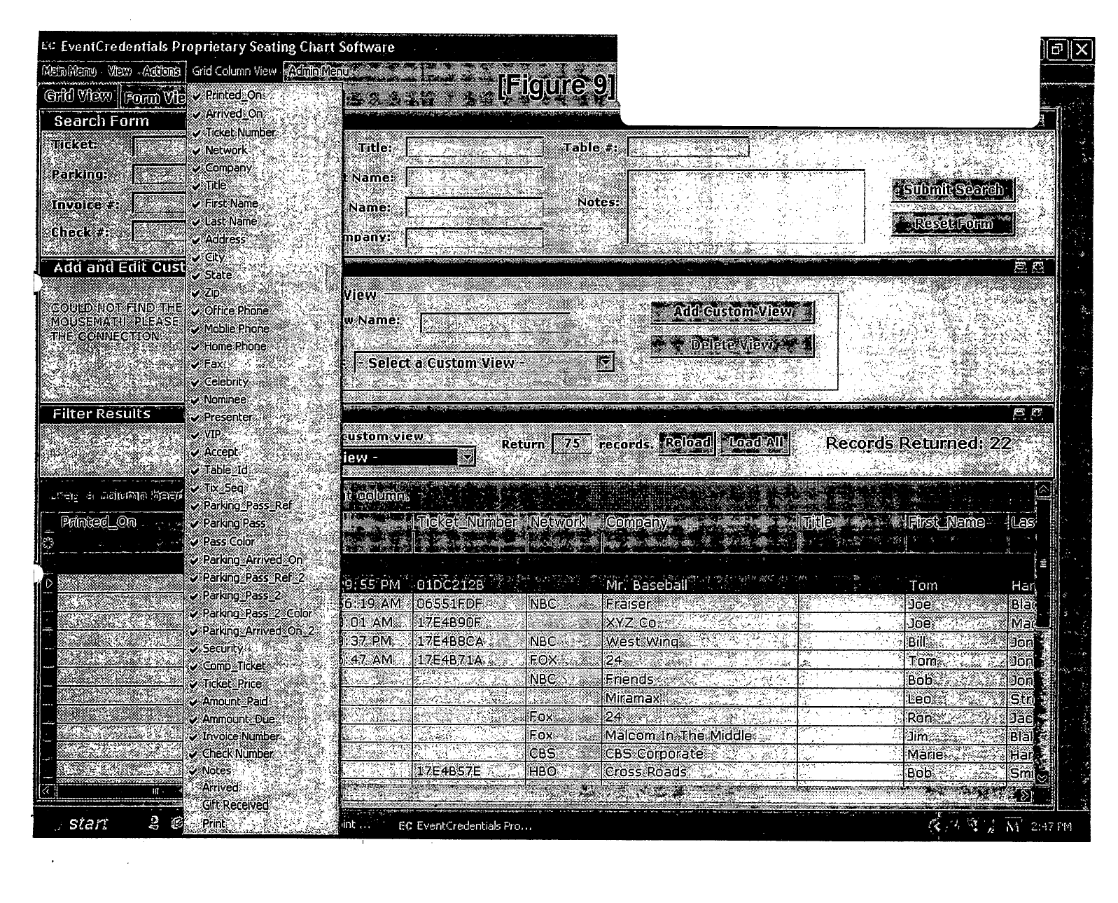

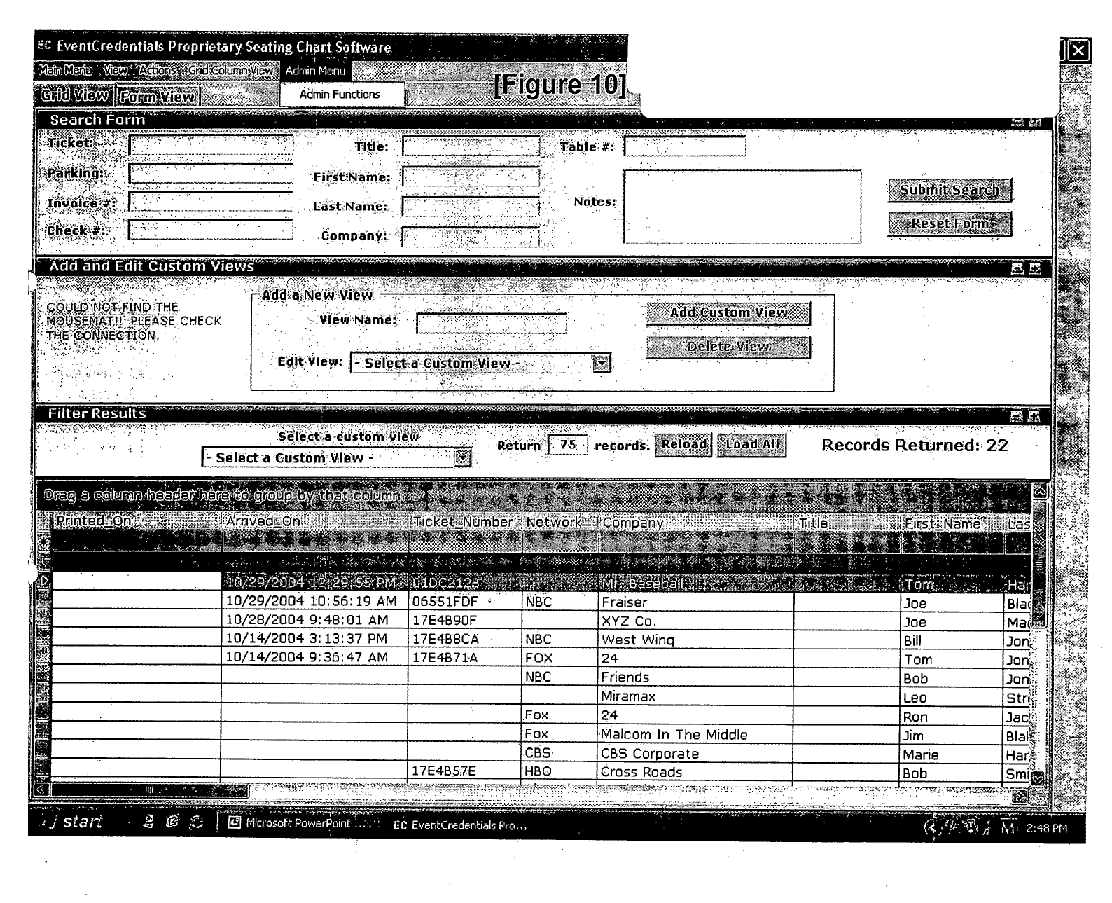

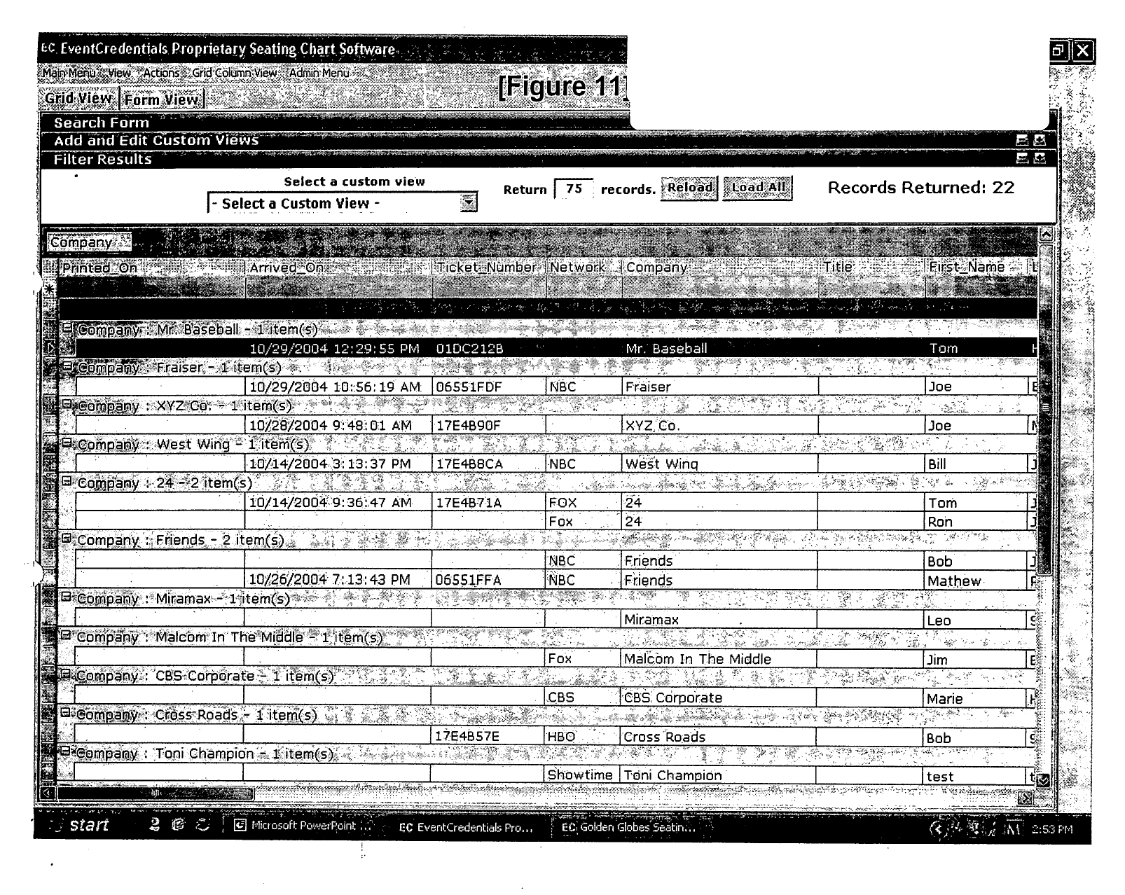

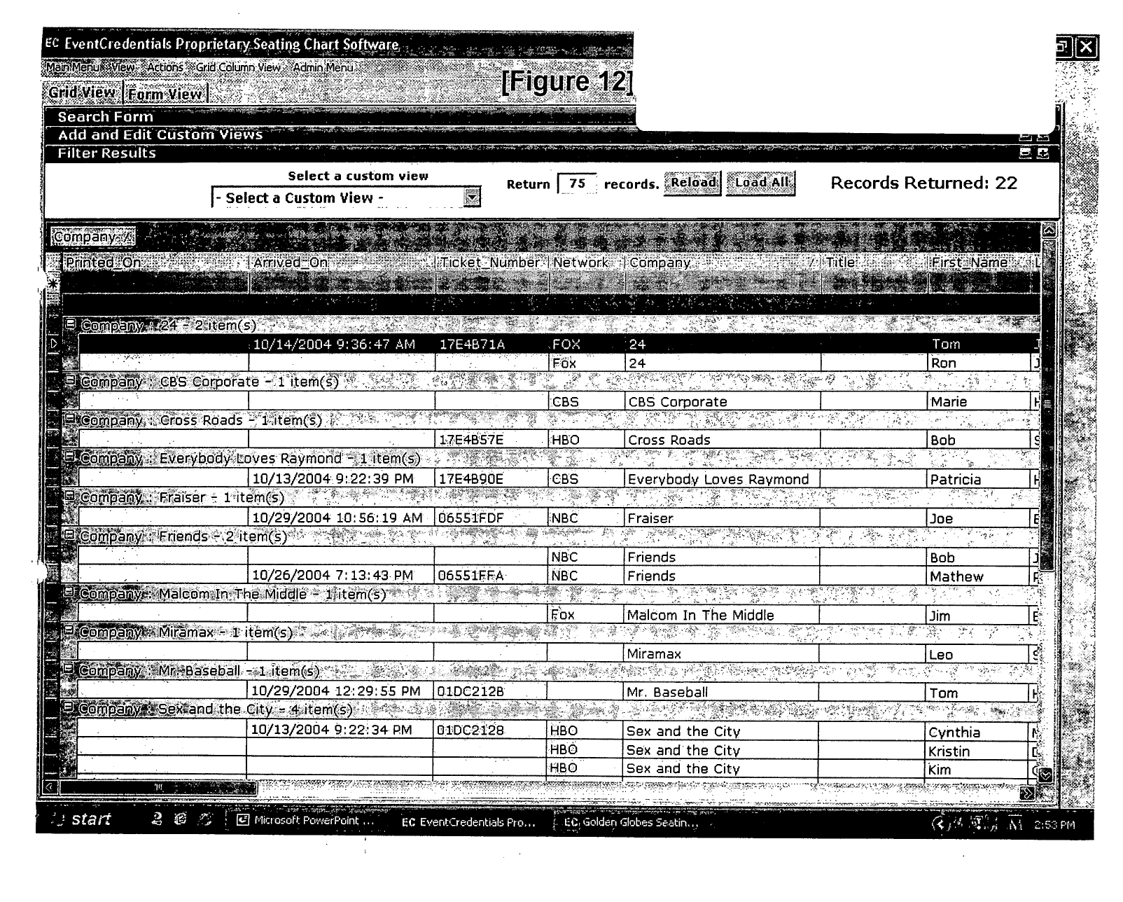

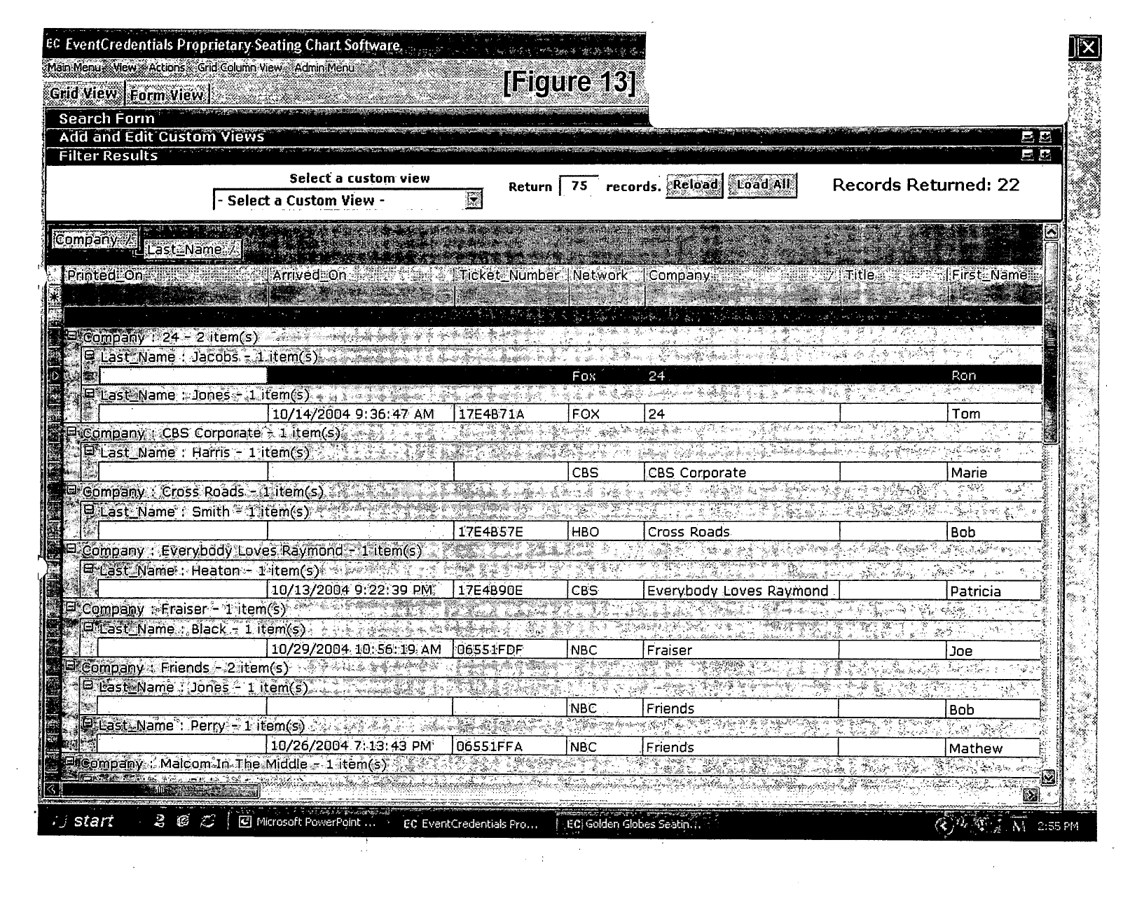

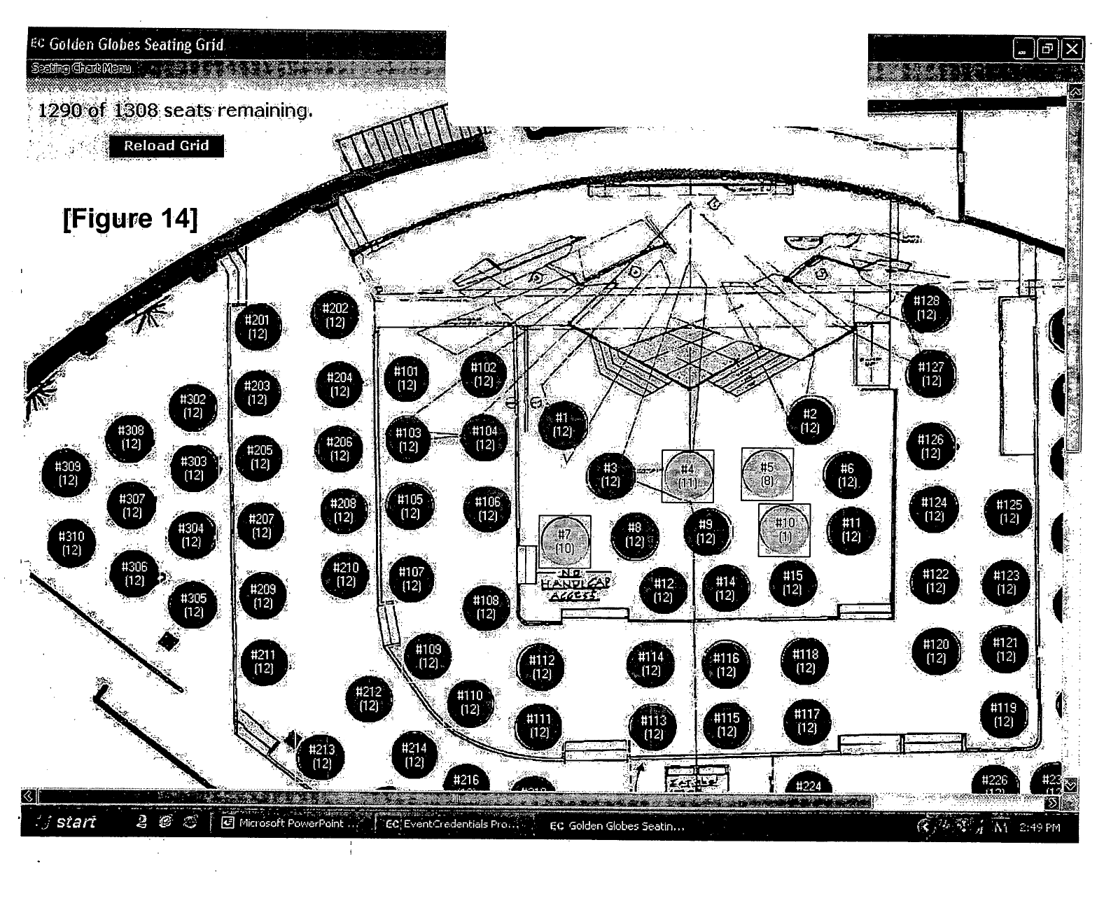

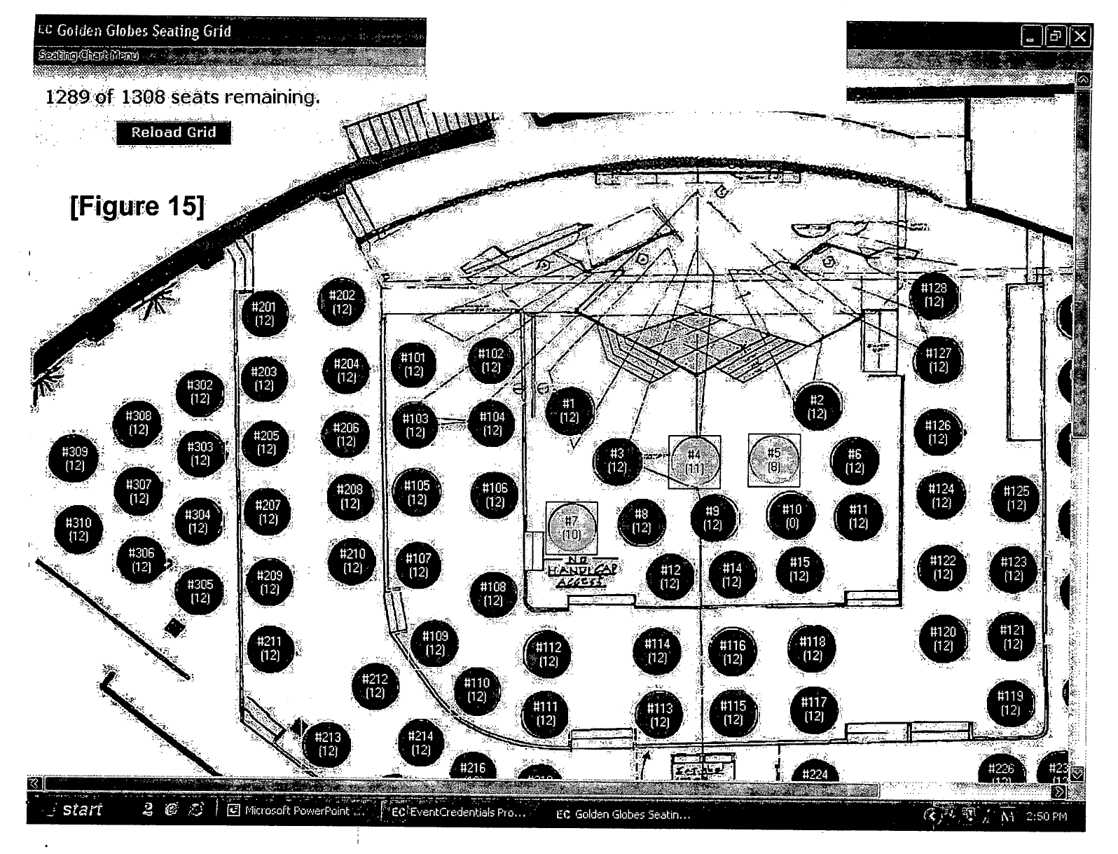

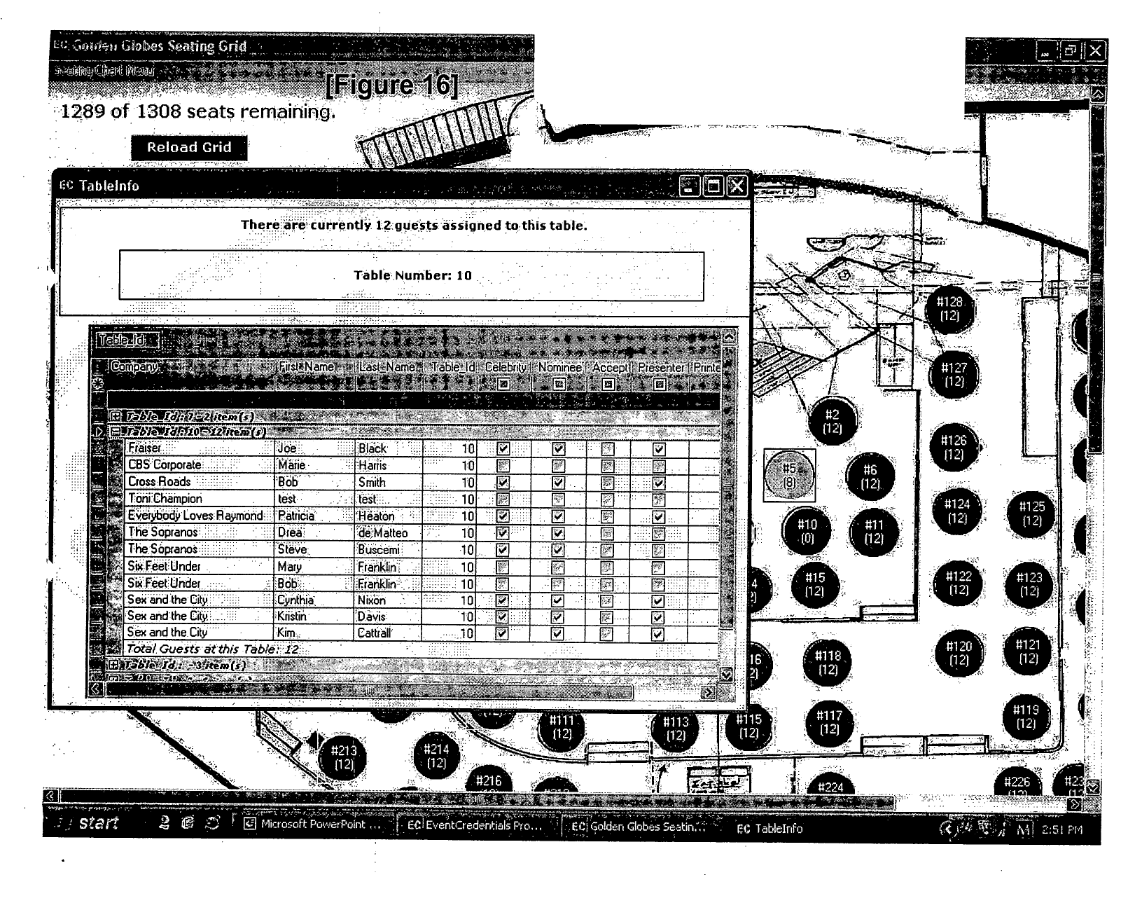

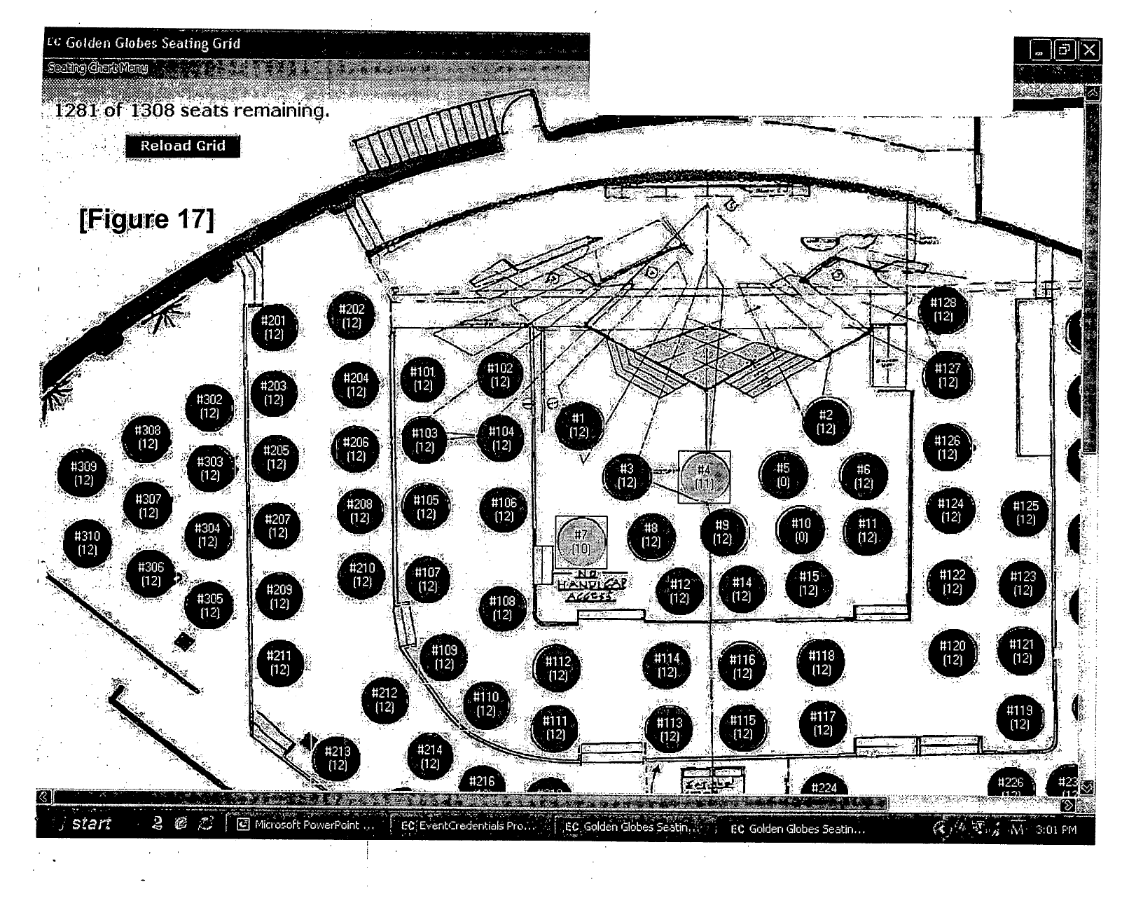

In an embodiment, the Live User Data screen allows the user to view the records that have been entered into or gathered by the system.

In an embodiment, the Printed Tickets screen allows the user to view which tickets have been flagged with a time/date stamp associated with their printing.

In an embodiment, the Tickets Not Printed screen allows the user to view which tickets have not been printed and are awaiting final printing.

In an embodiment, the Retired Tickets screen allows the user to view any tickets that have been deactivated and potentially replaced by new tickets. When a new ticket with a new number is entered into a record to replace an old ticket, the number of the old ticket is forwarded to the retired ticket area. This can also be achieved when radio-frequency identification (RFID) embedded tickets are used. When a new ticket is scanned into the database, the old ticket's serial number associated with that record is forwarded to the retired area for tracking purposes.

FIG. 8 is an exemplary screen shot illustrating the different actions that can be associated with a record, according to an embodiment of the invention. For example, the user can issue one or more complementary tickets, or the user can undo the issuance of one or more complementary tickets. In an embodiment, the user can undo the Retirement or deactivation of one or more tickets. Further, the user has the option of downloading the database or the currently selected view to a worksheet, such as an Excel worksheet, or the like.

FIG. 9 is an exemplary screen shot illustrating the various data fields currently associated with the database, according to an embodiment of the invention. In an embodiment, the database is customized to fit the individual needs of the function or the event for which it is being used. In an embodiment, a check mark represents that the data field is currently viewable in the grid, while selecting the data field again will automatically uncheck the data field and automatically eliminate it form the grid view. Thus, the user can build the view in which they would like to see the data returned. In addition, column headers can be moved and placed according to the user's preference in an embodiment.

FIG. 10 is an exemplary screen shot illustrating a form in which an Administrator would log into the system to manipulate the configuration of the database structure and modify the functionality of the software code, according to an embodiment of the invention.

FIG. 11 is an exemplary screen shot illustrating the filtering/sorting of the database in groupings, according to an embodiment of the invention. In an embodiment, the user drags the column header in which they would like to filter/sort the database up into the shaded area, which automatically signals the grid to separate and group the grids records. Records can be sorted individually or in groupings.

FIG. 12 is an exemplary screen shot illustrating the ascending/descending of a filter/sort by selecting the column header, according to an embodiment of the invention.

FIG. 13 is an exemplary screen shot illustrating the sort within a sort function, according to an embodiment of the invention. This occurs when records have been previously sorted by data category and then sorted again by another data category, while keeping the integrity of the first or original filter/sort.

FIG. 14 is an exemplary screen shot illustrating the Graphical User Interface Seating Chart Diagram, according to an embodiment of the invention. In an embodiment, multiple colors can be assigned to the table or seats to indicate the state of occupancy of the tables or seats.

FIG. 15 is an exemplary screen shot further illustrating the color coded action taken when a table or seat has reached it's maximum occupancy, according to an embodiment of the invention. In an embodiment, Green, Yellow, and Red colors are associated to icons to help the user identify the status of a table or seat. In this example of a Seating Chart Diagram View, the user can quickly and accurately see the running total of available tables/seats in the left corner, as well as quickly reference the table/seat number on the table/seat icon. In the case of a table view, the icon also has a built in function to automatically (in real time) add or reduce as well as visually show the number of seats remaining for use.

FIG. 16 is an exemplary screen shot illustrating the graphic user interface (GUI) functionality of the software, according to an embodiment of the invention. In an embodiment, by selecting on the table/seat, a window will be displayed showing the results for the selected table/seat. In this view, the user can accurately account for the individuals who have been assigned a seat at this table. Furthermore, in an embodiment, the window allows the user to view other table or seats by selecting a button that expands or retracts the grid or rows associated with that table. The user can edit/change the table/seat number in this grid (or drag and drop the record to a table on the chart) and in real time, the changes with regards to the table or seating calculations will automatically take place.

FIG. 17 is an exemplary screen shot illustrating of the Graphical User Interface Seating Chart/Ticketing Software, according to another embodiment of the invention.

### DETAILED DESCRIPTION OF THE PREFERRED EMBODIMENT

For a more detailed understanding of the invention, reference is made to an exemplary embodiment usable in, for example, the entertainment industry. However, an artisan will recognize from the disclosure herein, more general applicability to many different industries and many different applications.

An event is an organized gathering of people that can range from fewer than 10 to more than 15,000 participants. The event venue often contains an assigned location, such as a seat, a spot, a parking spot, a table, and the like for the attendees. In an embodiment, event organizers can limit the number of people assigned to each assigned location for security purposes, safety regulations, safety considerations, functionality, and the like. Figure A is a block diagram illustrating an embodiment of an online seating and/or table and ticketing assignment software system. Figure B illustrates another embodiment of an online seating and/or table and ticketing assignment software system.

### Data Gathering and Record Creation (Figure C blocks 101-103)

Figure C illustrates an embodiment of a seating assignment and ticketing process. In block 101, event coordinators log into the system using a unique ID and password assigned to them.

In block 102, event coordinators gather data on those invited or requesting access to an event. The coordinator creates a unique record for each attendee.

During the registration and data gathering process, the event coordinator has the option of entering the data through a form view or grid view. In an embodiment, the event organizer chooses in which format they want to enter the data.

Data gathered for each attendee's unique record includes, but is not limited to, attendee's name, company, role at event (i.e. nominee, presenter, guest) title, payment form, and the like.

Data for each attendee's record can be gathered by phone, mail, email, fax, electronically online through internet, online ticket request (approved by administrator and flows directly to database), etc. In an embodiment the software could allow the attendees the option to review the seating/table diagram electronically and to select where they would like to be assigned a seat/table. An Online payment process, in an embodiment, could be used to confirm the transaction and lock in the attendees requested seat(s)/table(s). The Coordinator could review and approve such seat/table assignment or modify it at a later time.

The system also provides accounting features for each specific record. This allows a Coordinator to use drop down menu to assign price for ticket associated with that record. The Coordinator also has option to choose complimentary status for ticket. The Coordinator can also enter any payment amount received and system will then automatically calculate payment amount still due.

The creation of a record is automatically time stamped upon creation.

In block 103, each unique record is stored in database for latter recall.

### Record Review, Modification and Manipulation (Figure C blocks 104-107)

In block 104, event coordinator(s) have the ability to recall records stored in database in either grid or form view. In an embodiment, a running record of the total records in the database is viewable at top of screen page.

The Coordinator has the ability to sort, search and/or manipulate records in database based on any field of data captured or to be potentially entered in the future as seen in block 105.

Coordinator also has ability to set the number of records to be returned on a page view for a grid sort. In an embodiment, 75 records can be returned on each page in the grid view.

In the grid view the coordinator has the ability to sort the grid data alphabetically/numerically (ascending/descending) and the like, by each individual field column header. The Coordinator can also search using partial or full word or number sequence searches. In an embodiment, entering the first few letters of a name will return the records beginning with those characters. The Coordinator has the ability in the grid view to select any record in the grid and open that individual record up into a form view.

The Coordinator has ability to sort records individually or by groupings of any field(s) of data captured or to be captured in the future. The System also allows user to sort within a sort or group (double sorting). In an embodiment, the coordinator can sort by company name and then sort within this sort by last name alphabetically, or by table number in ascending order, and the like.

In block 106, the Coordinator has the ability to create, save, and edit custom record views/formats for recall of created custom format after new additional records and/or additional data to already created records have been added. The Coordinator has the ability to drag and drop column field headers around and anywhere in the grid in order to customize/create a preferred view. In an embodiment, the Coordinator can decide to view the attendee's name, title, table number. The Coordinator would create this view and save it for easy recall. When in this custom view, the records retrieved would be displayed in this custom view format. The System also allows the Coordinator to easily turn any grid column field(s) on/off in the display screen. Turning them off hides them from current view. Printable format automatically adjusts to the current format of the grid view.

In block 107, the Coordinator has the ability to create custom reports to display specific data fields for all records. The ability to save custom views permits easy recall of a saved view after new additional records are added or additional data is added to previously created records.

In an embodiment, the records and reports are easily printable and downloadable to Excel, for example, and other applicable programs.

### Seating Assignment (Figure C block 108)

In block 108, the System also allows coordinator to assign a seat, spot, and/or table, and the like to the attendees' records. Seats, spots, and/or tables can be assigned by the event coordinator by placing seat/table number in specified field in record. Such assignment then auto-populates the seat/table in the graphical chart seating diagram. In the alternative, the Coordinator can leave the seat/table field for a record blank and wait to assign the seat/table in the visual graphical chart diagram section (view) at a later time. In another embodiment, the coordinator could use any field of data collected in records to make auto-population assignment. In an embodiment, records of individuals from a specified company could be automatically assigned certain seats, slots tables or the like based on their company affiliation.

The System allows coordinator to load in a graphical seating or slot or the like diagram of a facility or create a diagram from scratch by generating and placing tables, seats and the like where desired. Coordinators have ability to modify the physical positions of seats/tables and the like.

In an embodiment, the graphical seating/table chart diagram can be used to later assign seats and tables or the like to records entered without a seat, table, or the like, or to change previously assigned seats, tables, or the like.

The graphical chart diagram allows the coordinator to visually see table and/or seat number of each table and/or seat by placing it in the icon of such table and/or seat. The graphical diagram also allows the coordinator to see a color, such as red, in the icon denoting a full table or seat taken when there are no seats remaining at the table. In an embodiment, the Coordinator views a different color, such as green, denoting that there is an open seat or table with one or more open seats at it available for Coordinator to assign an attendee to such seat/table. The System also allows coordinator to see exact number of open seats still available at table, by denoting such open number inside icon representing table/seat. The diagram automatically repopulates upon any change made to a seat and/or table in either the record grid or form view or in the graphical diagram. If an attendee is added to, or moved off a table, in the graphical diagram view the total number of attendees at that table will increase or decrease automatically. In addition, seat or table number of the like will be automatically changed in attendee's unique record in database.

The System prevents double filling of a seat or over population of table, by automatically making it impossible to add an attendee to a full seat or table or the like until coordinator opens up a slot at full seat or table by removing a previously assigned attendee from such position. Then a new attendee can be placed at such seat/table. In an embodiment, the coordinator can open such seat or the like by either moving the record of the attendee in the graphical diagram to another seat icon or by changing that attendee's seat number or the like in his record.

In an embodiment the total number of seats assigned as well as seats still available at all tables is totaled and displayed, repopulated automatically, at the top of diagram page any time a change is made in the graphical diagram view, or in the grid or form view.

The System also provides the Coordinator with the ability to click on an icon of seat, table, spot, or the like and create one or multiple split screens that show lists of who is at which seats, tables, or the like. In the split screen view, the graphical diagram remains, but the grid view of the records at table selected, or the like, appears as well. The Coordinator also has the ability to view and edit records of multiple tables, seats or the like at once in this split screen format. The seating chart diagram and grid and form views repopulate automatically upon such making of such changes in grid view or diagram view.

In an embodiment, the Coordinator has ability to electronically drag and move attendee from one table, seat or the like to another. The change is automatically captured and saved in attendees' record. The diagram repopulates automatically.

### Printing of Personalized Ticket, Pass or the like (Figure C blocks 109-113)

In block 109, after a record is complete for the attendee, including, in an embodiment, the assignment of the assigned location, a personalized pass, such as a ticket, a parking pass, and the like can be printed by the system. In an embodiment, the ticket can be printed with name, table, seat, etc. or any other data collected and saved in the record can be printed on the pass. Upon printing of the ticket, the system software automatically records in the attendee's record the time and date that their ticket was printed.

In block 110, the enhanced technological ticket (and/or parking pass) or the like is scanned and activated. In an embodiment an RFID chip, or like technology, can be embedded in the ticket, pass, or the like. Both the personalized ticket and the parking pass with the embedded RFID chip (with a unique ID number) are scanned and automatically captured (with time/date stamped) and recorded in record of attendee. In another embodiment, a bar code or like technology could be printed on ticket and provide the same type of tracking number to be entered into individual's record in database.

In an embodiment, any data stored in a record in the database can be programmed on to the RFID chip or like technology, if so desired and then embedded in the ticket or pass.

Tickets are then distributed to the attendees in block 111.

The System allows a ticket to be deactivation or retired at any time. If deactivated, the record of attendee associated with ticket automatically flows to the deactivation/retired folder in database. In an embodiment if a ticket is scanned, an event record in database will indicate that the ticket has been deactivated, retired, or the like, and the user of the ticket can be denied entry. Deactivated tickets and the like, can be reactivated in database by the coordinator at any time for use.

In block 112, a ticket or a record in the database can be programmed to allow for one or a pre-defined number of entries. Re-entry can be flagged or denied. In an embodiment, the attendee scans the ticket upon exit and scans the ticket a second time upon re-entry. In another embodiment, the ticket auto-expires at a time specified in the attendee's record.

### Arrival Process at Event (Figure D blocks 201-205)

In block 201, at the time of the event, attendee arrives at event and presents their ticket, pass, parking pass, or the like at the entrance. In another embodiment, any information collected in database on the attendee could be printed on a list used at the door for entrance, in the alternative to a ticket, pass or the like.

In block 202, scanners, which, in an embodiment can be RFID scanners, computer kiosks, or handheld/tablet PCs devices, and the like, are placed at entrance or throughout event. In an embodiment, such devices can be networked by LAN, WAN, WiFi, Intranet, Internet, analog, or digital hardwired/wireless devices and the like. In an embodiment, the scanner could also have the database in its memory and not be in communication with the server comprising the database.

In an embodiment tickets embedded with RFID chips, other scannable devices, or the like technology, are scanned upon entrance in block 203. Upon scanning of the ticket, the unique record of the holder/attendee is retrieved based on the unique RFID serial number. In an embodiment, the reading equipment scans the chip built into the ticket/parking pass, electronically goes to database and retrieves record associated with unique serial ID in chip. The database returns to the reader's display monitor any data associated with that record so desired or that has been preprogrammed to be returned. In an embodiment, data could include that attendee's (ticket holder's) name, photo, driver's licenses number, etc. or any other data collected in database and saved in attendee's unique record.

The display on the scanner's screen or monitor verifies if ticket is valid for event and entrance is granted or denied. In an embodiment, colors can be used to show access granted or denied, such as a green light for access, and a red light for denial of access. In another embodiment, any data collected and stored in the record in the database can be displayed on the scanner monitor at the time of scanning, including, but not limited to, the validation of the ticket, or the like.

In block 204, the record and data associated with the record in the database can be changed in real time in the database and the change can be reflected on scanner at time ticket is read. In an embodiment, coordinators could assign the seat, or the like, after the ticket, or the like, is issued to the attendee and the attendee could be notified of the seat assignment/table assignment at time of entrance to the event by having the assignment displayed on the scanning monitor.

Upon arrival, in an embodiment, the scanning of the ticket is captured in the attendee's record in the database in the arrival field, showing the time and date the attendee arrived. In an embodiment, this allows the coordinators to track the guest arrival and the attendance in real time. In an embodiment, the database shows, in real time, the last entrance point at which the attendee's ticket has been scanned and the time and date the attendee's ticket was scanned at that entrance point. The System keeps a running log of entrance points that the attendee with the ticket has passed through. In an embodiment, the system also has the ability to show who is in what seat or at what table in real time for monitoring on the backend by the event coordinator.

In block 205, the System prints reports. In an embodiment, the system generates customized guest lists and other reports based on any field of data.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions, and changes in the form of the methods and systems described herein may be made without departing from the spirit of the inventions.

What is claimed is:

1. A method of assigning an assigned location at an event for an authorized attendee, the method comprising:
creating an electronic record having at least one data field comprising data for at least one authorized attendee requesting attendance to an event;
storing the record in a sortable, searchable and manipulatable electronic database that is viewable in at least a form view and a grid view;
modifying the record in the database to include an assignment for a location at the event, said location being viewed on a graphical user interface diagram of the event venue, where the graphical user interface diagram can either be created by a user or downloaded if already in existence;
auto-populating data from the record in the database into the graphical user interface diagram based on the location assigned in the data field in the record;
automatically saving in the record location assignments assigned in the graphical user interface diagram;
updating the data as necessary;
issuing a pass to the attendee;
displaying data in the record associated with the pass, wherein the data comprises validation information and the location assignment; and
automatically capturing and storing in the database a date and a time the pass was issued.

2. The method of claim 1 further comprising:
selecting the record in the grid view and opening the grid view record in the form view;
dragging and dropping column and row headers associated with the data field to create a custom view from the form view or the grid view; and
saving and editing any of the custom view, the form view, and the grid view after new data to the database has been added.

3. The method of claim 1 wherein the step of updating the data comprises:
viewing on a split screen the graphical user interface diagram and the record, wherein the record is sorted by the column or row header of the record;
modifying the record to include the location assignment by electronically selecting the record and dropping the record into the assigned location in the graphical user interface diagram;
selecting the assigned location in the graphical user interface diagram, and viewing the record of the attendee that is assigned to the location; and
selecting the record assigned to a first table and dragging and dropping the record into a second table on the graphical user interface diagram, and automatically updating the assigned location in the record in the database from the location associated with the first table to the location associated with the second table.

4. The method of claim 1 wherein the step of issuing the pass comprises:
printing on the pass data stored in the record in the database;
automatically capturing and storing a date and a time that the pass was printed;
capturing and storing in the record for the attendee a unique identification code associated with the pass when the pass is activated;
deactivating or retiring the pass before or after the pass has been distributed by changing the record in the database associated with the pass;
displaying data in the record associated with the pass, when the pass is scanned by a scanning device upon arrival at the event;
programming data from the record onto a RFID chip that is attached to the pass associated with the record; and
scanning the pass having scannable technology upon entrance to the event.

5. A method of creating a seating chart for an event, the method comprising:
creating a record in a database for at least one event attendee;
storing in the record a unique code, said code uniquely associated with a pass which permits the at least one attendee admittance to an event;
storing in the record for the at least one attendee a seat assignment at the event after the pass is distributed;
updating the seat assignment in the database after the pass is distributed to permit a user to reassign the attendee to a different seat assignment after the pass is distributed; and
communicating a most recent seat assignment stored in the database to the attendee upon presentation of the pass at the event.

6. The method of claim 5 further comprising retrieving the record from the database upon presentation of the pass, and displaying the seat assignment.

7. The method of claim 5 further comprising changing the record to deactivate the pass after the pass has been distributed.

8. The method of claim 5 further comprising storing in the record a table assignment.

9. The method of claim 5 further comprising retrieving information from the record associated with the event attendee for printing on the pass associated with the event attendee.

10. The method of claim 5 further comprising automatically storing in the database a date and a time the pass was printed.

11. The method of claim 5 further comprising storing in the record the unique code associated with the pass when the pass is activated.

12. The method of claim 5 further comprising displaying data from the record associated with the pass on a scanning device when the pass is scanned.

13. The method of claim 5 further comprising programming data from the record onto a radio frequency identification device that is attached to the pass associated with the record.

14. The method of claim 5 further comprising scanning the pass and retrieving the record associated with the pass from the database, and displaying data stored in the record.

15. The method of claim 5 further comprising automatically storing in the database a date and a time the pass was scanned.

16. A method of creating a seating chart for an event, the method comprising:
creating a record in a database for at least one event attendee;
displaying the created record on an electronic display electronically connected to the database;
displaying a graphical seating diagram comprising at least one table icon corresponding to at least one table at an event on the electronic display;
modifying the record to include a table assignment for the at least one attendee by electronically selecting the record and dropping the record onto the table icon; and
updating automatically the table icon in the graphical seating diagram to indicate the number of remaining unassigned seats at the table when the record is modified to include the table assignment for the attendee.

17. The method of claim 16 further comprising auto populating the graphical seating diagram with data collected in each record in the database.

18. The method of claim 16 further comprising assigning the table assignment in the graphical seating diagram, and automatically saving the table assignment in the record.

19. The method of claim 16 further comprising selecting a table icon in the graphical seating diagram and automatically viewing the records of the attendees assigned to the table associated with the table icon.

20. The method of claim 16 further comprising changing the table assignment in the record by selecting a record associated with a first table icon and dropping the record onto a second table icon, wherein the record is automatically updated with the table assignment associated with the second table icon.
